(19) United States
(12) Patent Application Publication
(10) Pub. No.: US 2009/0168809 A1
(43) Pub. Date: Jul. 2, 2009

(54) METHOD AND APPARATUS TO JOINTLY SYNCHRONIZE A LEGACY SDARS SIGNAL WITH OVERLAY MODULATION

(75) Inventors: Carl Scarpa, Plainsboro, NJ (US); Edward Schell, Jackson, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: Sirius XM Radio Inc., New York, NY (US)

(21) Appl. No.: 12/183,980

(22) Filed: Jul. 31, 2008

Related U.S. Application Data
(60) Provisional application No. 60/962,780, filed on Jul. 31, 2007.

(51) Int. Cl. H04J 3/06

(52) U.S. Cl. 370/503

(57) ABSTRACT

Methods and apparatus are presented for the joint synchronization of legacy signals with overlay modulation signals in a communications system utilizing a hierarchical modulation scheme. In exemplary embodiments of the present invention, a synchronization signal can be sent in each of the legacy and overlay bit streams, each using a different approach to frame synchronization, and the two synchronization signals can be used in a complementary manner to synchronize both bit streams. In exemplary embodiments of the present invention a legacy physical frame and an overlay physical frame can be aligned in time. In exemplary embodiments of the present invention a key synchronization signal in a legacy bit stream can be time distributed throughout a legacy transmission frame and can be utilized to assist in both the synchronization of such legacy bit stream and of an overlay bit stream. Additionally, in exemplary embodiments of the present invention, a key synchronization signal in an overlay bit stream can be sent in one fixed physical frame of an overlay transmission frame, and can be utilized to assist in the synchronization of such overlay bit stream as well as legacy data, in a manner that complements the use of the synchronization signal provided in the legacy bit stream.

### CROSS REFERENCE TO RELATED APPLICATIONS

This application claims the benefit of and hereby incorporates by reference U.S. Provisional Patent Application No. 60/962,780 entitled “METHOD AND APPARATUS TO JOINTLY SYNCHRONIZE A LEGACY SDARS SIGNAL WITH OVERLAY MODULATION”, filed on Jul. 31, 2007.

### TECHNICAL FIELD

The present invention relates to broadcast communications utilizing hierarchical modulation, and more particularly to systems and methods to jointly synchronize a legacy signal with one or more overlay modulation signals.

### BACKGROUND OF THE INVENTION

In certain broadcast communications systems, such as, for example, satellite radio, in order to optimize the utilization of a fixed bandwidth, hierarchical modulation (“HM”) can be used to overlay data for new services on top of a legacy transmission. Such a scheme can be used, for example, to offer additional channels or services. For example, in the Sirius Satellite Radio, Inc. (“Sirius”) Satellite Digital Audio Radio Service (“SDARS”), video channels can be sent over existing audio channels via such an overlay modulation scheme, where the video signal is sent in a “Layer 2” or overlay modulation layer, on top of an existing audio service, known as the “legacy” signal.

There are many approaches to hierarchical modulation, each utilizing a further modulation of a transmitted legacy bit or symbol as to amplitude, phase or a combination of the two. For example, hierarchical modulation can involve the perturbation of original legacy QPSK symbol constellation points, which can, for example, carry audio and data traffic, to convey additional information, such as, for example, video. Thus, for example, such an overlay modulation scheme can carry video data fully independently of the legacy data (original QPSK symbol) carrying a variety of audio channels. For example, Sirius' Backseat TV™ service uses an overlay modulation technique to send video on top of its existing legacy audio channels.

In such systems it is important that the legacy signal be synchronized with the HM signal. It is also advantageous to utilize synchronization techniques at an HM layer that can complement whatever synchronization methods are used at the legacy layer. What is thus needed in the art are techniques, apparatus and methods to jointly synchronize such legacy and HM signals.

### SUMMARY

Methods and apparatus are presented for the joint synchronization of legacy signals with overlay modulation signals in a communications system utilizing a hierarchical modulation scheme. In exemplary embodiments of the present invention, a synchronization signal can be sent in each of the legacy and overlay bit streams, each using a different approach to frame synchronization, and the two synchronization signals can be used in a complementary manner to synchronize both bit streams. In exemplary embodiments of the present invention a legacy physical frame and an overlay physical frame can be aligned in time. In exemplary embodiments of the present invention a key synchronization signal in a legacy bit stream can be time distributed throughout a legacy transmission frame and can be utilized to assist in both the synchronization of such legacy bit stream and of an overlay bit stream. Additionally, in exemplary embodiments of the present invention, a key synchronization signal in an overlay bit stream can be sent in one fixed physical frame of an overlay transmission frame, and can be utilized to assist in the synchronization of such overlay bit stream as well as legacy data, in a manner that complements the use of the synchronization signal provided in the legacy bit stream.

### BRIEF DESCRIPTION OF THE DRAWINGS

FIG. 1 depicts exemplary legacy and overlay transmission frame formats according to an exemplary embodiment of the present invention;

FIG. 2 illustrates transmission frame alignment according to an exemplary embodiment of the present invention; and

FIG. 3 depicts exemplary TDM demodulator with overlay processing used in connection with exemplary embodiments of the present invention.

### DETAILED DESCRIPTION

In general, the present invention can be applied to any communications system which employs the use of hierarchical modulation to transmit secondary information. For example, in order to support future services within an original system design (i.e., a “legacy system”), additional information bandwidth can be acquired by using hierarchical modulation to overlay data for new services on top of the legacy transmission. In particular, for example, in a satellite communications network, such as, for example, Sirius' SDARS, such overlay data can be transmitted by applying a programmable angular offset to legacy QPSK symbols, thus forming a new constellation similar to 8PSK. Alternatively, various other techniques for implementing hierarchical modulation can also be utilized, including modulation of the amplitude, phase or a combination of amplitude and phase, of a legacy bit stream that has already been modulated at a first layer.

In the case of Sirius' SDARS, for example, coded information for each of legacy audio data and overlay data can be conveyed by the use of extensive Forward Error Correction (FEC) and interleaving coding schemes. To successfully decode either data stream, a first task is, for example, to recover a frame synchronization signal, which indicates the boundary point for the FEC scheme and the interleaving scheme.

For example, as a frame synchronization signal, an SDARS legacy data stream can use, for example, a time distributed 255-bit PN (pseudo-random noise) sequence, each bit being repeated, for example, five (5) times within a transmission frame. It is often the case that legacy data de-interleaving processes, as well as FEC decoding processes, are highly dependent upon recovering such a key synchronization signal.

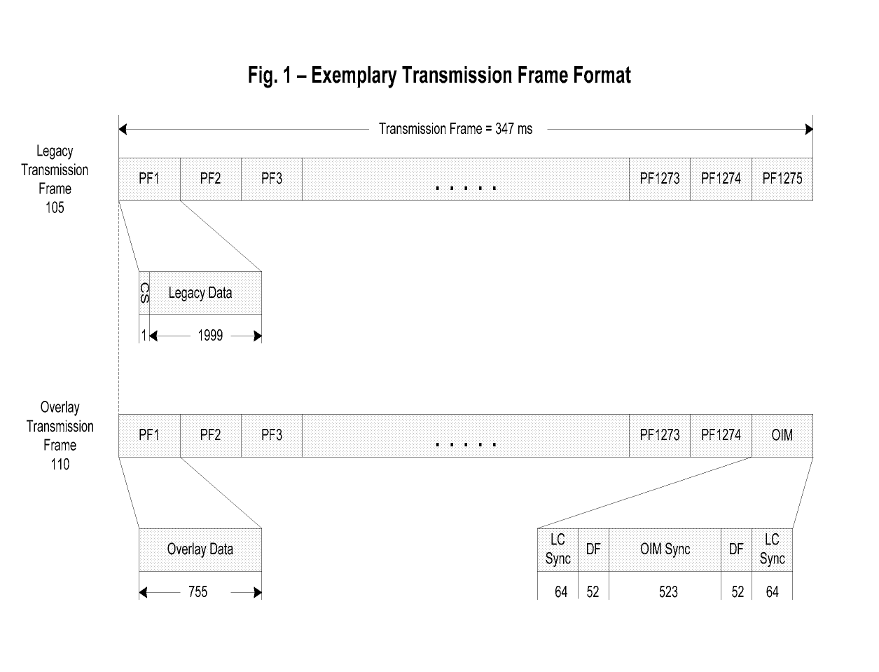

FIG. 1 depicts an exemplary transmission frame format for an exemplary SDARS using two layers of modulation, a legacy transmission frame 105 and an overlay transmission frame 110. The overlay transmission frame is, of course, overlayed on the legacy data. As shown in FIG. 1, the exemplary legacy frame has, for example, 1275 physical frames, labeled as PF1 through PF1275, where “PF” stands for “physical frame.” Each physical frame (“PF”) has 2000 bits, i.e., an initial “CS” bit followed by 1999 legacy data bits.

The initial bit is labeled “CS” for “Cluster Sync.” Thus, an exemplary synchronization signal for the exemplary legacy transmission frame can, for example, be sent 1 bit at a time following each physical frame boundary point, i.e., PF1 to PF1275 in FIG. 1. Thus, for a transmission frame comprising 1275 physical frames, such a 255-bit PN synch signal can be sent five times. In general, in exemplary embodiments of the present invention, such a time distributed synchronization signal can, for example, have a number of bits that is an integral factor N of the number of physical frames in a transmission frame, such that it can be completely sent N times in each transmission frame. It is the task of each receiver's demodulator to recover this synchronization signal. As is known, Sirius' SDARS utilizes two TDM signals and one COFDM signal, as is described in U.S. Pat. No. 6,618,367, the disclosure of which is fully incorporated herein, and such an SDARS can utilize a 255-bit PN synchronization signal for its legacy data stream. Thus, for example, in such a Sirius SDARS it is the task of each of the TDM1, TDM2 and COFDM demodulators to recover this 255-bit synchronization signal.

In exemplary embodiments of the present invention, an overlay data stream can, for example, also provide a sync signal, and can also, for example, use a different approach to frame synchronization. For such an overlay data stream, in exemplary embodiments of the present invention a 523 bit alternating PN sequence, known as an Overlay Identification Marker (“OIM”) synchronization signal, can, for example, be placed within the last physical frame of each overlay transmission frame, as shown in the exemplary overlay transmission frame 110 of FIG. 1. Here such a PN pattern can thus, for example, be transmitted only at physical frame number 1275. In FIG. 1, such an exemplary OIM synchronization signal is thus labeled “OIM Sync.” Surrounding the OIM Sync are “LC Sync” and “DF” fields, which are used to convey other information relating to the overlay bit stream, which are not relevant to the use of the OIM Sync signal.

Thus, in exemplary embodiments of the present invention, unlike the legacy sync signal, the overlay sync signal is not time spread over the entire frame. It is noted that in the exemplary legacy and overlay transmission frames of FIG. 1, the number of bits per each of the 1275 physical frames comprising each transmission frame are different. This is due to the fact that in the exemplary depicted system one overlay bit is used for each two legacy bits, inasmuch as the legacy bits are transmitted as QPSK symbols (which represent two bits) and the overlay bits are transmitted as an angular offset of such QPSK symbols (such angular offset representing one bit), resulting in an approximately 2:1 legacy/overlay ratio. As can be seen with reference to FIG. 1, there are 755 overlay bits shown, and in the depicted exemplary embodiment another 237 bits are reserved for a layer 3 overlay bit stream, thus making a total of 992 available overlay bits, corresponding to 1984 legacy bits. The legacy PF also has 16 bits—carried by eight legacy I,Q symbols—that are not overlay modulated, i.e., the 1 shown CS bit and an additional 15 bits per legacy PF that are allocated to service channel messaging, for a total of 2000 bits per PF in the legacy bit stream, as shown. As noted, in alternate exemplary embodiments of the present invention, any overlay modulation scheme can be used (with various layers), which may or may not result in a similar 2:1 legacy/overlay bit ratio, and in such cases, an overlay transmission frame may have a different structure.

In exemplary embodiments of the present invention, a key system requirement for the generation of each of the legacy data stream and the overlay data stream can, for example, be that each transmission frame, i.e., legacy and overlay, must be of the same duration and exactly aligned in time. This feature can, for example, offer considerable advantages for improved reception of both the legacy and the overlay signals. The fact that in such a method two different synchronization markers are used to identify the same transmission boundary, said synchronization markers being in different time slots and of different duration, can be exploited to improve the reception for both data streams.

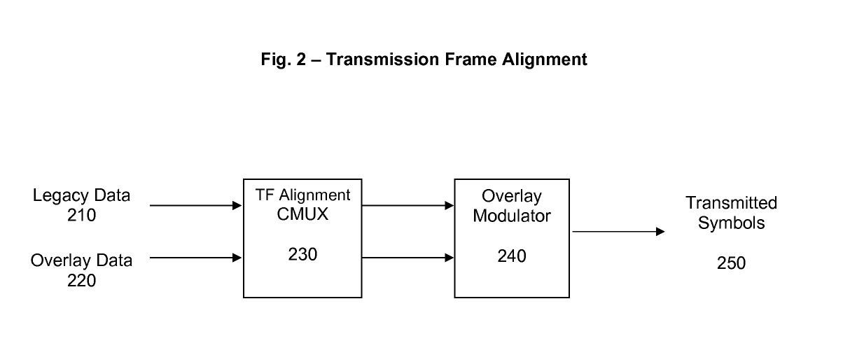

FIG. 2 depicts an exemplary alignment process according to an exemplary embodiment of the present invention, where completely independent bit streams for each of exemplary legacy data 210 and overlay data 220 are fed to a transmission frame alignment composite multiplexer (CMUX) 230. The CMUX 230 can ensure, for example, that the two bit streams, legacy and overlay, are aligned in time prior to being sent to a modulator 240, such as, for example, a QPSK modulator, that supports overlay modulation. The overlay modulator 240 outputs transmitted symbols 250 having multiple layers of modulation.

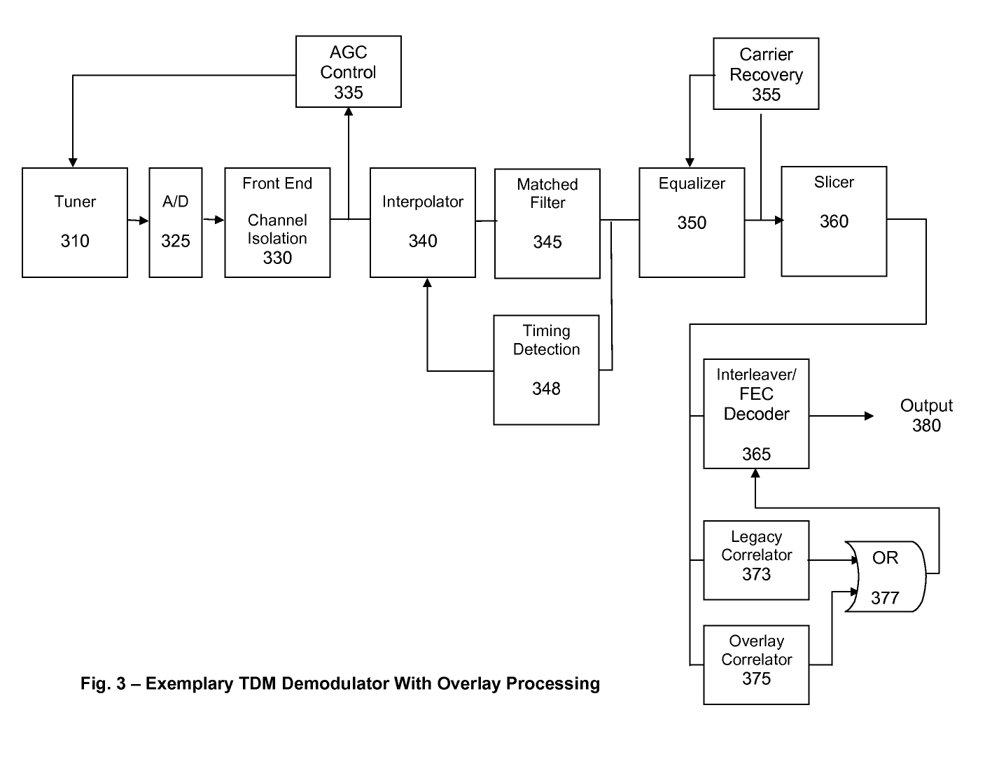

At a receiver, in exemplary embodiments of the present invention, the detection of each PN sequence can, for example, be performed by independent correlators. FIG. 3 depicts an exemplary TDM receiver with overlay processing which can be used, for example, in connection with exemplary embodiments of the present invention. The exemplary TDM receiver of FIG. 3 illustrates the use of independent legacy and overlay correlators, as next described.

With reference to FIG. 3, there is shown Tuner 310, which receives a broadcast signal from the air and outputs it to A/D converter 325, which in turn, outputs a digital form of the received signal to Channel Isolation 330. The out put of Channel Isolation 330 is fed to Interpolator 340, but is also fed to AGC Control 335, which feeds back a gain control signal to Tuner 310. From Interpolator 340 the signal is input to Matched Filter 345, whose output is sent to Equalizer 350, but is also sent to Timing Detection module 348, which in turn sends a timing signal back to Interpolator 340, allowing it to achieve timing recovery. From Equalizer 350 the signal is sent to Slicer 360, which separates the Layer 2 (overlay) data from the received symbols. Additionally, the output of Equalizer 350 is also sent to Carrier Recovery 355 which provides feedback to Equalizer 350. Equalizer 350 cleans up the signal form any distortion, whether due to filtering, the channel, etc. Many equalizers have a carrier recovery module embedded in them, and thus feedback from a carrier recovery module to an equalizer is easily accomplished. The feedback from Carrier Recovery 355 to Equalizer 350. From Slicer 360 the signal is sent to each of Interleaver/FEC Decoder 365, Legacy Correlator 373 and Overlay Correlator 375. The outputs of Legacy Correlator 373 and Overlay Correlator 375 are both fed to an OR gate, OR 377, whose signal can be used to resynchronize Interleaver/FEC Decoder 365, and thus its output is fed back to Interleaver/FEC Decoder 365, which then generates output signal 380.

Thus, in exemplary embodiments of the present invention, QPSK soft decisions can be, for example, applied to a legacy correlator directly. Then, for example, OIM correlation first requires overlay data to be sliced from the received legacy soft symbols. These sliced decisions can then, for example, be applied to an overlay correlator, as shown for example, in FIG. 3

For the exemplary sync signals of the exemplary transmission frame format of FIG. 1, the detection of the legacy frame sync signal is normally more robust (as compared to detection of the overlay frame sync signal) due to its longer time duration (1275 bits versus 523 bits) and the fact that the depicted exemplary overlay signal is approximately 12 dB less in power with respect to the depicted exemplary legacy waveform. Overlay bit streams generally have lower power than legacy bit streams due to the smaller separation between possible overlay symbols relative to the separation between legacy symbols. Thus, in exemplary embodiments of the present invention, for each receiver the main synchronization signal can, for example, be based on the sync signal sent in the legacy data stream. As legacy frame syncs are lost, the normal operation for receivers is to flywheel until the next valid legacy sync signal is received. Unfortunately, under such conditions, such usual receiver operation can cause loss of a signal for major portions of a transmission frame. This, in turn, can cause local clocks to drift, which can lead to de-interleaver and FEC slip. Under such conditions the use of an OIM sync can aid in maintaining proper alignment. Thus, in such exemplary embodiments, the legacy sync signal, rather than flywheeling freely, can be reset once an OIM signal (containing the OIM sync) has been received. Thus, the same operation, i.e., the detection of the transmission frame boundary, can be used for both legacy and overlay processing to provide the most robust frame synchronization signal possible.

As noted, Sirius' SDARS utilizes two TDM signals and one COFDM signal, as is described in U.S. Pat. No. 6,618,367. In Sirius' COFDM transmission, for example, the legacy frame sync bit (i.e., the CS bit sent in each physical frame, or PF) can be sent in the same exact FFT bin. This leads to the possibility that a static multipath null can possibly preclude detection. That is, such a cluster sync pattern does not use any of the frequency diversity that is available in an COFDM system. Spectral nulling of the cluster sync FFT bin is known as the slow speed mute problem. Here again, in exemplary embodiments of the present invention, OIM detection can be used to completely avoid this problem. Since the OIM is spread over an entire physical frame, which is mapped to an entire FFT symbol, the OIM thus takes full advantage of the frequency diversity in the COFDM system. Static nulls generally do not cause loss of the OIM signal. Thus, detecting the OIM (and thus OIM sync) to reset the legacy flywheel circuit completely avoids the slow speed mute issue.

While the present invention has been described with reference to certain exemplary embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed:

1. A method for jointly synchronizing a legacy signal with an overlay modulation signal, comprising:
inputting independent bit streams for each of legacy data and overlay data to a composite multiplexer, said composite multiplexer aligning the two bit streams in time; and
sending the aligned bit streams to a modulator that supports overlay modulation, wherein each of the legacy and overlay bit streams contain a different synchronization signal.

2. The method of claim 1, wherein the legacy synchronization signal is sent one bit at a time, one bit per physical frame of the legacy transmission frame.

3. The method of claim 1, wherein the overlay synchronization signal is sent all together, in a defined Nth physical frame in each transmission frame.

4. The method of claim 1, wherein the legacy synchronization signal is time spread over an entire transmission frame.

5. The method of claim 1, wherein the overlay synchronization signal is not time spread over an entire transmission frame, and is of a different time duration than the legacy sync signal.

6. The method of claim 1, wherein the legacy synchronization signal assists in the synchronization of the overlay bit stream and the overlay sync signal assists in the synchronization of the legacy bit stream.

7. The method of claim 1, wherein the legacy bit stream is QPSK modulated, and the overlay bit stream modulates each QPSK symbol with one bit of overlay data.

8. The method of claim 7, wherein the overlay data is used to modulate the phase of each QPSK legacy symbol.

9. The method of claim 8, wherein the overlay layer of modulation comprises applying a programmable angular offset to said legacy QPSK symbols.

10. A system, comprising:
a legacy data source and an overlay data source, each generating a legacy bit stream and an overlay bit stream;
a framer, generating a transmission frame for each of the legacy and overlay bit streams, each said frame having an embedded synchronization signal;
a transmission frame alignment CMUX; and
an overlay modulator,
wherein the legacy and the overlay bit streams are input to the CMUX and time aligned, and wherein the time aligned bit streams output form the CMUX are input to the overlay modulator.

11. The system of claim 10, wherein the legacy synchronization signal is sent one bit per physical frame of the legacy transmission frame.

12. The system of claim 10, wherein the overlay synchronization signal is sent all together, in a defined Nth physical frame in each transmission frame.

13. The system of claim 10, wherein the legacy synchronization signal is time spread over an entire transmission frame.

14. The system of claim 10, wherein the legacy bit stream is QPSK modulated, and the overlay bit stream modulates each QPSK symbol with one bit of overlay data.

15. The system of claim 14, wherein the overlay data is used to modulate the phase of each QPSK legacy symbol.

16. A program storage device readable by a processing unit, tangibly embodying a program of instructions executable by the processing unit to implement a method of jointly synchronizing a legacy signal with an overlay modulation signal, said method comprising:
inputting independent bit streams for each of legacy data and overlay data to a composite multiplexer, said composite multiplexer aligning the two bit streams in time; and
sending the aligned bit streams to a modulator that supports overlay modulation, wherein each of the legacy and overlay bit streams contain a different synchronization signal.

17. The program storage device of claim 16, wherein the legacy synchronization signal is sent one bit at a time, one bit per physical frame of the legacy transmission frame.

18. The program storage device of claim 16, wherein the overlay synchronization signal is sent all together, in a defined Nth physical frame in each transmission frame.

19. The program storage device of claim 16, wherein the legacy synchronization signal is time spread over an entire transmission frame.

20. The program storage device of claim 16, wherein the overlay synchronization signal is not time spread over an entire transmission frame, and is of a different time duration than the legacy sync signal.

21. The program storage device of claim 16, wherein the legacy synchronization signal assists in the synchronization of the overlay bit stream and the overlay sync signal assists in the synchronization of the legacy bit stream.

22. The program storage device of claim 16, wherein the legacy bit stream is QPSK modulated, and the overlay bit stream modulates each QPSK symbol with one bit of overlay data.

23. The program storage device of claim 22, wherein the overlay data is used to modulate the phase of each QPSK legacy symbol.

24. The program storage device of claim 22, wherein the overlay layer of modulation comprises applying a programmable angular offset to said legacy QPSK symbols.

25. A receiver, comprising:
a receiving stage to receive legacy data I,Q symbols that have been further modulated with overlay data, each of the legacy and overlay data streams containing an embedded sync signal;
a legacy correlator;
an overlay correlator;
an overlay modulation detection stage to detect the value of at least one parameter of said overlay modulation as transmitted; and
an overlay demodulation stage to detect a direction of the overlay modulation,
wherein I,Q symbol soft decisions are directly applied to a legacy correlator directly, wherein overlay data is then sliced from the received legacy I,Q symbols, and wherein said sliced decisions are applied to the overlay correlator.

26. The receiver of claim 25, wherein the legacy I,Q symbols are QPSK modulated.

27. The receiver of claim 26, wherein the overlay layer of modulation comprises applying a programmable angular offset to said legacy QPSK symbols.

28. The receiver of claim 25, wherein the main synchronization signal is based on the sync signal sent in the legacy data stream.

29. The receiver of claim 25, wherein a lost legacy sync signal can be reset once the overlay sync signal has been received.

30. The receiver of claim 25, wherein said overlay synchronization signal is sent all together, in a defined Nth physical frame in each transmission frame.

31. The receiver of claim 25, wherein said legacy synchronization signal is time spread over an entire transmission frame.

32. The receiver of claim 30, wherein COFDM signals are received, and wherein the receiver detects said overlay synchronization signal and uses it to reset a legacy flywheel circuit.
